(19) United States
(12) Patent Application Publication
(10) Pub. No.: US 2007/0144071 A1
(43) Pub. Date: Jun. 28, 2007

(54) Gear motor

(76) Inventor: Michael Hoermann, Halle/ Westf (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/642,468

(22) Filed: Dec. 19, 2006

(30) Foreign Application Priority Data
Dec. 23, 2005 (DE) 20 2005 020 106.5

(51) Int. Cl. E05F 15/00; H02H 7/08; G05D 3/00

(52) U.S. Cl. 49/199; 318/445; 318/466

(57) ABSTRACT

The present disclosure relates to a gear motor, preferably for driving a door, comprising a motor and a transmission flanged to the same with a central, continuous hollow shaft and a plug-in shaft adapted to the profile shape of the hollow shaft, which serves as an output shaft.

### CROSS REFERENCE TO RELATED APPLICATION

This application claims priority to German Utility Model No. DE 20 2005 020 106.5, filed Dec. 23, 2005, which is hereby incorporated by reference in its entirety for all purposes.

### BACKGROUND AND SUMMARY

The present disclosure relates to a gear motor, comprising a motor and a transmission flanged to the same, wherein this gear motor preferably is used for driving a closure element, such as a door.

In particular in the case of a garage door drives it is known to provide the motor with a flange-mounted transmission. A drive shaft extending from the transmission carries output means, for instance a chain wheel, which are disposed in a slide rail section, where they move a carriage connected with a closure means, i.e. for instance the garage door, via a chain or some other transmission means. Depending on the output means to be attached, different output axles must be used here.

It is the object of the present disclosure to develop a gear motor such that the same can easily be connected with the output means.

In accordance with the present disclosure, this object is solved by various combinations of the features disclosed herein. Accordingly, there is created a gear motor comprising a motor and a transmission flanged to the same, which includes a central, continuous hollow shaft, in which a plug-in shaft can be inserted, which is adapted to the profile shape of the hollow shaft and serves as an output shaft.

In accordance with the present disclosure, the output shaft can exclusively be mounted in the drive corresponding to this solution. This means that the hollow shaft can be mounted at low cost without any external influences or loads.

The insertable plug-in axle can be selected corresponding to the respective target system, i.e. the corresponding output means.

Other embodiments of the present disclosure may comprise various additional elements. For example, the plug-in shaft can be secured axially via snap rings.

The hollow shaft preferably can have a gear-like profile shape.

A protrusion of the plug-in shaft projecting beyond the transmission can be used as a rotary encoder.

An output means with the same profile shape as the hollow shaft can be pushed onto the plug-in shaft as an output shaft. Such output means can be a chain wheel or a toothed pulley.

The corresponding chain wheel or the toothed pulley can be incorporated in the slide rail section. A protrusion of the plug-in shaft projecting beyond the transmission can be used as a rotary encoder, but in a particularly advantageous aspect of the present disclosure, the speed-detecting sensor unit is integrated in the transmission housing. For this purpose, a pulse wheel and a housing-mounted sensor should be provided. The pulse wheel can be attached to the worm gear driving the hollow shaft.

The gear motor of the present disclosure does not require an axial guideway inside the drive.

Advantageously, a symmetrical housing and symmetrical screw-on points can provide for right-hand assembly as well as for left-hand assembly. Depending on the space conditions, the axle can be mounted in the hollow shaft from the left or from the right. Thus, one gear motor is obtained for both applications.

Due to the fact that the hollow shaft extends across the entire width of the transmission and that the plug-in shaft serving as an output shaft therefore protrudes from the hollow shaft on both sides, a sensor unit can be incorporated on the side of the transmission housing opposite the output means. This sensor unit can for instance be a speed-detecting sensor unit.

Since the output shaft can easily be inserted, a plurality of motors can be interconnected via one shaft.

### BRIEF DESCRIPTION OF THE FIGURES

Further features, details and advantages of the present disclosure will be explained in detail with reference to an embodiment illustrated in the drawing, in which:

FIGS. 1a-1f show various views of a partly represented gear motor in accordance with a first embodiment of the present disclosure,

FIGS. 2a-2d show an alternative embodiment of a gear motor in accordance with the present disclosure, and

FIGS. 3a-3f show a third embodiment of a gear motor in accordance with the present disclosure.

### DETAILED DESCRIPTION

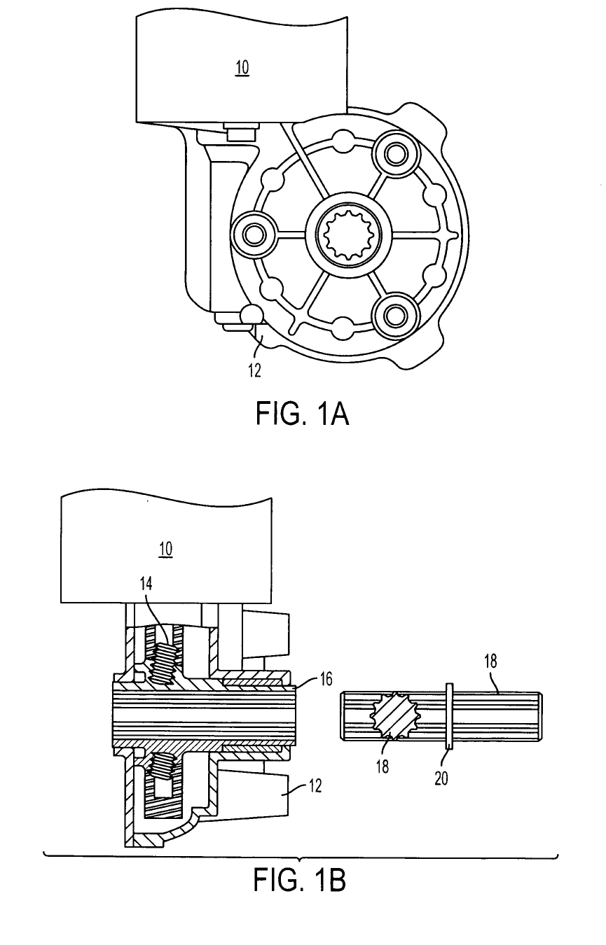

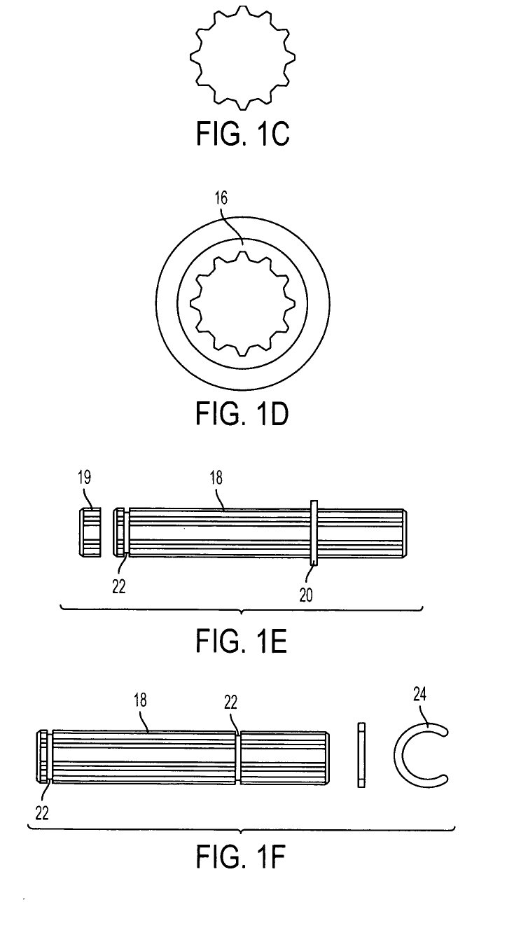

FIG. 1a shows top view of a gear motor in accordance with the first embodiment of the present disclosure, said gear motor comprising a motor 10 and a flange-mounted transmission 12. The partly sectional side view of FIG. 1b clearly shows that the motor 10 drives a worm 14, which inside the transmission 12 cooperates with a non-illustrated worm gear, in order to drive a hollow shaft 16 integrated in the transmission 12 and extending across the entire width of the transmission. The hollow shaft has a hollow profile, as is shown in a top view for instance in FIG. 1c. The shape of the hollow profile of the hollow shaft 16 can also be taken from the top view as shown in FIG. 1d. A plug-in shaft 18 serving as an output shaft, which is adapted to the profile shape of the hollow shaft, can be inserted into the hollow shaft. As shown in FIG. 1b, this plug-in shaft has a cross-section similar to that of a gear wheel.

As an axial system, an abutment 20 is formed on the plug-in shaft 18, which here is formed by a snap ring 24 engaging in a corresponding groove 22. This embodiment can be obtained with the plug-in shafts as shown in FIGS. 1e and 1f, respectively. The plug-in shafts 18 can be inserted into the hollow shaft 16 in different lengths, as required. An extension of the protruding part of the plug-in shaft 18 can be used for instance as a rotary encoder for a speed measurement. In the representation of FIG. 1e, a correspondingly extended version of the plug-in shaft 18 alternatively is designated with the reference numeral 19. A non-illustrated sensor can cooperate with this extended protrusion of the plug-in shaft. Due to the continuous plug-in shaft 18, the speed sensor unit thus can be disposed on the side of the transmission opposite the output element not shown in detail in FIG. 1.

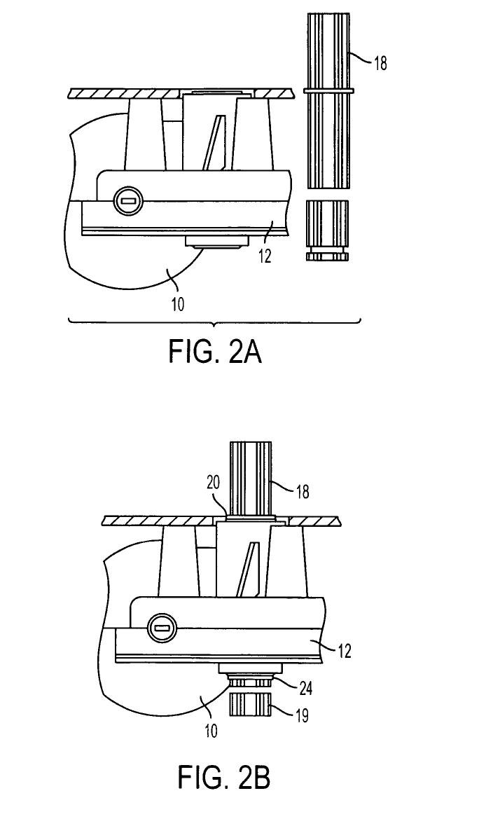

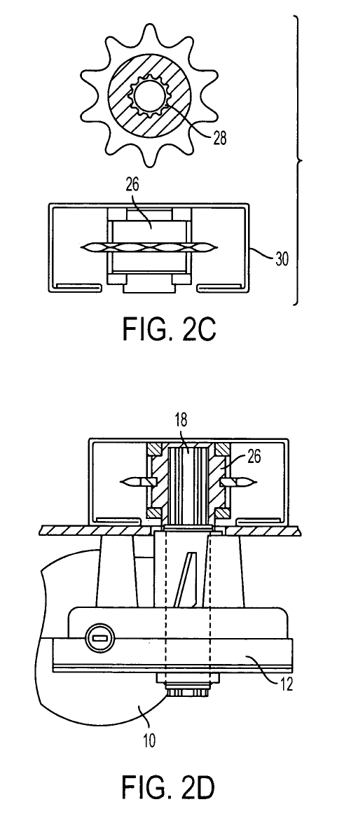

In the embodiment as shown in FIG. 2, the motor 10 with a flange-mounted transmission 12 as shown in FIG. 2a is illustrated separate from the plug-in shaft 18. In the representation of FIG. 2b, the plug-in shaft 18 already is inserted up to its abutment 20 and also is secured axially on the opposite side of the transmission via the snap ring 24. In the representation of FIG. 2b, the longer version 19 of the plug-in shaft 18 is shown, as here said protrusion 19 can again be used as a rotary encoder. FIG. 2b shows an exploded view of the output means, namely in the present case the chain wheel 26, which, as shown in the corresponding top view of FIG. 2c, has an inner profile shape 28 which corresponds to the profile of the hollow shaft 16. The chain wheel thus can easily be pushed onto the plug-in shaft 18. In the embodiment shown here, the chain wheel 28 is shown in a slide rail section 30 of a commonly used garage door drive with a carriage reciprocable in a slide rail 30. In FIG. 2d, the chain wheel 26 is mounted on the plug-in shaft 18.

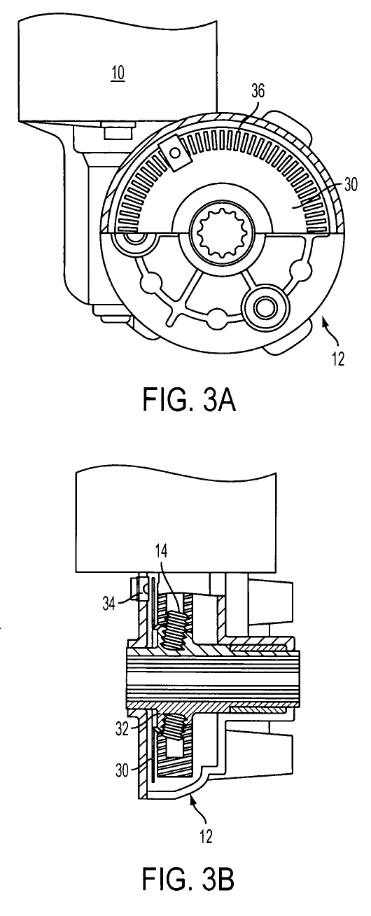

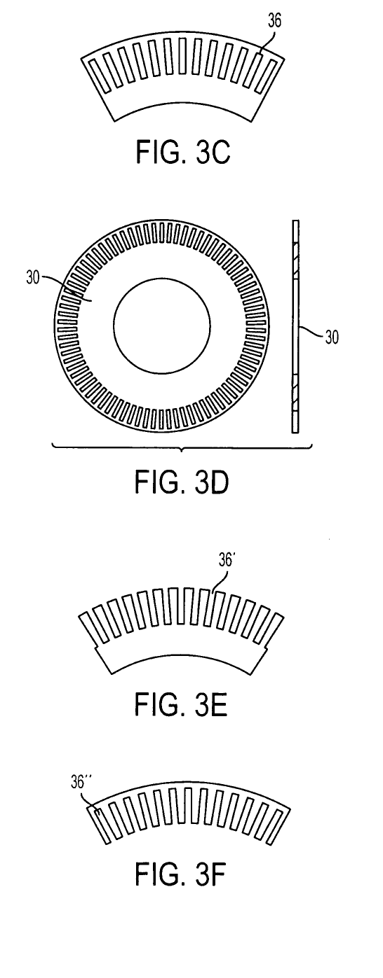

FIG. 3 shows a modification of the gear motor. Inside the transmission housing, a so-called pulse wheel 30 is disposed, which can be pushed onto the worm gear 32 driven by the worm 14. The pulse wheel can also be integrated in the transmission worm gear 32 as a coated insert. In this way, every transmission reduction has the precisely fitting pulse wheel 30. At a suitable point inside the housing of the transmission 12 a sensor 34 is integrated. The location of the sensor 34 is chosen such that the apertures 36 of the pulse wheel 30 inducing the pulses are guided past the sensor 34.

In the different representations of FIG. 3, different versions of the pulse wheel 30 are shown, and these different versions as shown in FIGS. 3a, 3c and 3d correspond to each other and each include slot-shaped openings 36. In the representations of FIGS. 3e and 3f, the pulse-inducing slots 36′ and 36″ are modified. As shown in FIG. 3, the pulse wheel 30 does not require any additional space inside the housing of the transmission 12. The sensor 34 can constitute a rather small part. There can for instance be chosen a Hall system or an inductive system. Due to its structure, the sensor unit is independent of the chosen transmission reduction or the motor speed. By slightly adapting the pulse wheel to the transmission data, the output signal of the sensor is identical for all transmission reductions and motor speeds. As a result, the control can be evaluated more easily.

1. A gear motor, comprising a motor and a transmission flanged to the motor with a central, continuous hollow shaft and a plug-in shaft adapted to the profile shape of the hollow shaft which serves as an output shaft.

2. The device of claim 1, characterized in that the plug-in shaft is axially secured via snap rings.

3. The device as claimed in claim 1, characterized in that the hollow shaft has a gear-like profile shape.

4. The device as claimed in claim 1, characterized in that a protrusion of the plug-in shaft projecting beyond the transmission serves as a rotary encoder.

5. The device as claimed in claim 3, characterized in that an output means with the same profile shape as the hollow shaft is pushed onto the plug-in shaft as an output shaft.

6. The device as claimed in claim 5, characterized in that the output means is a chain wheel or a toothed pulley.

7. The device as claimed in claim 6, characterized in that the chain wheel or the toothed pulley is incorporated in the slide rail section.

8. The device as claimed in claim 1, characterized in that a speed-detecting sensor unit including a pulse wheel and a sensor is integrated in the transmission housing.

9. The device as claimed in claim 8, characterized in that the pulse wheel is attached to the worm gear driving the hollow shaft.

10. The device as claimed in claim 1, wherein the device is for driving a door.
